(19) United States
(12) Patent Application Publication
(10) Pub. No.: US 2007/0298723 A1
(43) Pub. Date: Dec. 27, 2007

(54) METHOD AND SYSTEM FOR SIGNALING PERFORMANCE REQUIREMENTS OF A WIRELESS TRANSMIT/RECEIVE UNIT

(75) Inventors: Vincent Roy, Montreal (CA); Philip J. Pietraski, Huntington Station, NY (US); Ariela Zeira, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/747,643

(22) Filed: May 11, 2007

Related U.S. Application Data
(60) Provisional application No. 60/799,997, filed on May 12, 2006.

(51) Int. Cl. H04B 17/00

(52) U.S. Cl. 455/67.13; 455/67.11

(57) ABSTRACT

A method and apparatus for signaling information indicating performance requirements that a WTRU commits to satisfying from the WTRU to permit a more efficient allocation of radio resources and increase network capacity. The WTRU may signal information to the base station that includes performance requirements that the WTRU commits to satisfying, that includes a code or a field associated with at least one performance requirement. In another embodiment, the signaled information indicates a change in performance requirements committed to by the WTRU. In yet another embodiment, the WTRU signals channel quality measurements, such as channel quality indicator (CQI) report messages, to the base station, which in turn infers certain information regarding receiver performance based on the channel quality measurements.

### CROSS REFERENCE TO RELATED APPLICATION

This application claims priority from U.S. Provisional Patent Application No. 60/799,997 filed May 12, 2006 which is incorporated by reference as if fully set forth.

### FIELD OF INVENTION

The present invention relates to the field of wireless communication systems. More specifically, it relates to signaling information indicating performance requirements from a wireless transmit/receive unit (WTRU).

### BACKGROUND

As the mobile wireless communication industry continues to mature, advances in receiver techniques permits for the design of WTRUs that offer higher performance levels than WTRUs not using new receiver techniques. Examples of the advances in receiver techniques include the development and implementation of multi-antenna processing, interference cancellation, joint-detection techniques, advanced receiver structures, novel decoder schemes, etc. The performance levels refer to the performance that a WTRU is able to achieve using a given amount of allocated resources (i.e. allocated power, allocated code resources, allocated time resources, allocated frequency carriers, etc.). Performance is typically measured as throughput, but may also be expressed using other metrics such as latency, quality of service (QoS), etc.

WTRUs that offer higher performance levels in terms of throughput for a given amount of received energy typically use less radio resources than WTRUs not using the new receiver techniques. Further, WTRUs offering higher performance levels also provide benefits to an operator of a radio network in that WTRUs offering higher performance levels enable the operator to more efficiently use scarce radio resources thereby increasing radio network capacity. The operator of the radio network may also favor high performance WTRUs in the allocation of radio resources and may provide incentives for users to purchase WTRUs having higher performance levels. For example, the operator of the radio network may grant the users of higher performance WTRUs with priority of access, lower billing rates, or other incentives to upgrade to a higher performance WTRU.

In addition, a radio network may use a number of better performing WTRUs to increase the efficiency of the radio network. For example, the radio network may segregate its radio resources or use a sophisticated scheduling scheme to prevent WTRUs with lower performance from using a majority of the radio resources thereby degrading the overall performance and capacity of the radio network.

Further, WTRUs offering higher performance levels can meet higher performance requirements. A performance requirement is a test condition that specifies the performance level that a WTRU can satisfy. The wireless standard bodies have defined performance requirements to frame and standardize the performance expected from WTRUs employing the advances in receiver techniques. For example, the Third Generation Partnership Project (3GPP) has defined different performance requirements for each of at least four different types of receiver. A Type 0 receiver satisfies minimum performance requirements consistent with a rake receiver and a single receive antenna. A Type 1 receiver satisfies Type 1 performance requirements consistent with a rake receiver with receive diversity. A Type 2 receiver satisfies Type 2 performance requirements consistent with a minimum mean square error (MMSE) chip level equalizer and a single receive antenna. A Type 3 receiver satisfies Type 3 performance requirements consistent with a MMSE chip level equalizer with receive diversity. The standardization of additional receiver types is being further considered by 3GPP.

Unfortunately, there is a lack of means for the radio network to acquire information indicating the performance requirement met by each WTRU thereby preventing current wireless systems from capitalizing on the benefits described above. The prior art does not provide the means for a WTRU to communicate the performance requirement that the WTRU commits to reaching to the radio network. This lack of communication denies the radio network information that it could use to allocate radio resources in a wireless system more efficiently or to implement billing or service schemes that provide incentives for users to purchase more efficient and higher performance WTRUs. Therefore, the radio network is unable to efficiently use and allocate radio resources using the performance requirements of the WTRUs. As a result, a new mechanism that enables the radio network to be informed of the performance requirements that each WTRU commits to satisfying is necessary.

### SUMMARY

The present invention relates to a method for signaling information indicating performance requirements from a wireless transmit/receive unit (WTRU) to permit a more efficient allocation of radio resources and increase radio network capacity. Performance requirements indicate a standard performance expectation of the WTRU related to the receiver techniques employed in the WTRU. Each WTRU in a wireless system may be able to meet a plurality of different performance requirements. Further, each WTRU may dynamically adjust its performance levels, thereby changing the performance requirements the WTRU commits to satisfying.

More specifically, the present invention relates to a method for signaling information indicating performance requirements that a WTRU commits to satisfying. Further, the present invention relates to a method for signaling a change in the performance requirements committed to by the WTRU. In addition, the present invention relates to a method for inferring information regarding receiver performance in a WTRU using a plurality of channel quality measurements.

### BRIEF DESCRIPTION OF THE DRAWING

A more detailed understanding of the invention may be had from the following description, given by way of example and to be understood in conjunction with the accompanying drawing wherein:

FIG. 1 is a block diagram of a wireless communication system configured in accordance with the present invention;

FIG. 2 is a flow diagram of a signaling process for signaling information indicating performance requirements that a WTRU commits to satisfying implemented by the system of FIG. 1; and

FIG. 3 is a flow diagram of a process for inferring information regarding receiver performance in a WTRU operating in high-speed data packet access (HSDPA) mode using channel quality indicator (CQI) report messages implemented by the system of FIG. 1.

### DETAILED DESCRIPTION OF THE PREFERRED EMBODIMENTS

Hereafter, the terminology “wireless transmit/receive unit (WTRU)” includes but is not limited to a user equipment (UE), a mobile station, a fixed or mobile subscriber unit, a pager, or any other type of user device capable of operating in a wireless environment. When referred to hereafter, the terminology “base station” includes but is not limited to a Node-B, a site controller, an access point (AP) or any other type of interfacing device capable of operating in a wireless environment.

The features of the present invention may be incorporated into an integrated circuit (IC) or be configured in a circuit comprising a multitude of interconnecting components.

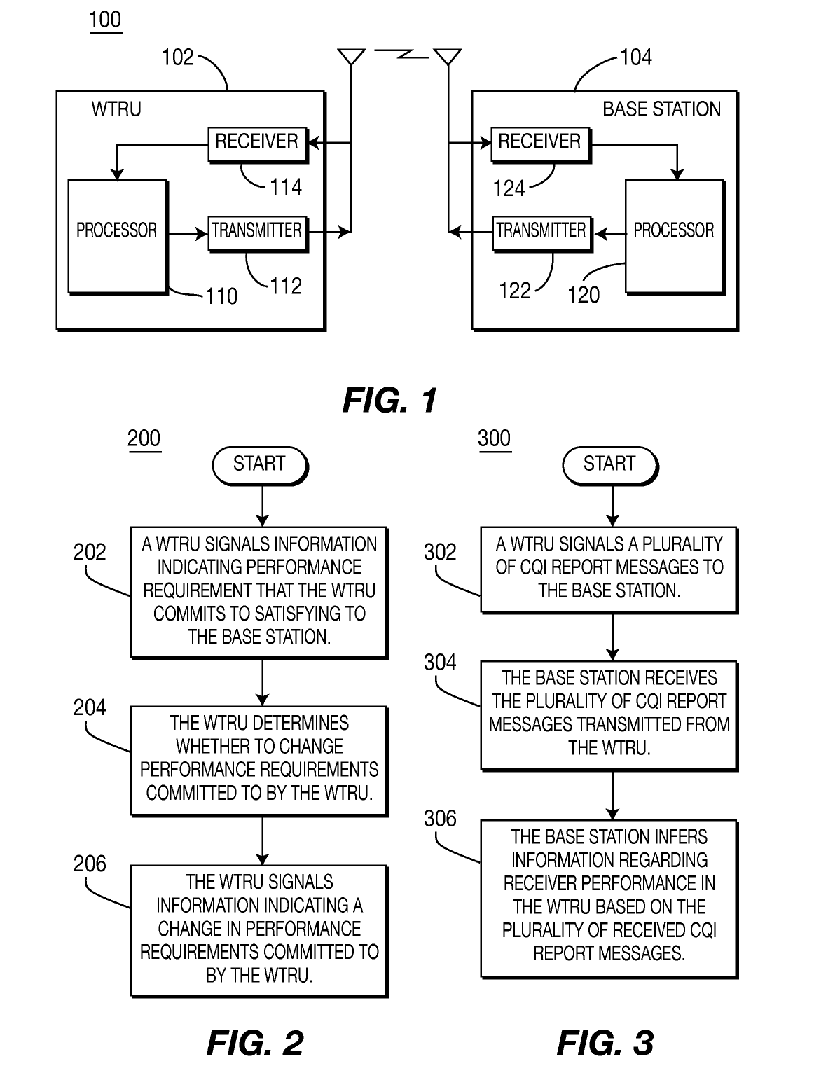

FIG. 1 is a block diagram of a wireless communication system 100 configured in accordance with the present invention. The system 100 includes a wireless transmit/receive unit (WTRU) 102 and a base station 104. The WTRU 102 and the base station 104 communicate via explicit signaling or implicit signaling using existing parameters.

As shown in FIG. 1, the WTRU 102 includes a processor 110, a transmitter 112, and a receiver 114. The processor 110 is configured to control the signaling of information indicating performance requirements that a WTRU commits to satisfying.

The transmitter 112 is configured to signal the information from the WTRU 102 to the base station 104. If the WTRU 102 is operating in HSDPA mode, the transmitter 112 is configured to signal a plurality of CQI report messages to the base station 104. The receiver 114 is configured to receive a plurality of signals from the base station 104.

Still referring to FIG. 1, the base station 104 includes a processor 120, a transmitter 122, and a receiver 124. The processor 120 is configured to control the allocation of radio resources using the received information indicating performance requirements that the WTRU 102 commits to satisfying.

The transmitter 122 is configured to transmit a plurality of signals to the WTRU 102. The receiver 124 is configured to receive a plurality of information signals from the WTRU 102 that indicate performance requirements that the WTRU 102 commits to satisfying. If the WTRU 102 is operating in HSDPA mode, the receiver 114 is configured to receive a plurality of CQI report messages signaled from the WTRU 102.

FIG. 2 is a flow diagram of a signaling process 200 for signaling information indicating performance requirements that a WTRU 102 commits to satisfying implemented by the system 100 of FIG. 1.

In step 202, the WTRU 102 signals information indicating performance requirements that the WTRU 102 commits to satisfying. For example, in 3GPP networks, this signaling could be done through common control channel signaling, dedicated control signaling, and/or other signaling means for the WTRU 102 to signal the base station 104.

The information signaled by the WTRU 102 indicates the performance requirement that the WTRU 102 commits to satisfying on a per channel basis or a per service basis. The WTRU 102 indicates to the base station 104 that it will adjust its own configuration in a way that satisfies a given performance requirement. In 3GPP, for example, the WTRU 102 may signal Type 0 performance requirements for monitoring a high-speed shared control channel (HS-SCCH) and Type 3 performance requirements for receiving packets on a high-speed downlink shared channel (HS-DSCH). The ability for the signaled information to indicate performance requirements on a per channel basis or a per service basis is useful because the WTRU is permitted to operate more efficiently, thereby reducing the overhead power in a cell. Therefore, the WTRU 102 is able to conserve power without fully degrading performance.

In a preferred embodiment, the information signaled from the WTRU 102 includes a code or field associated with at least one performance requirement. In 3GPP, for example, the code or field represents a particular receiver type that directly associates to a set of performance requirements. As stated above, examples of 3GPP receiver types are Type 0, Type 1, Type 2, Type 3, etc.

In an alternative embodiment, the information signaled from the WTRU 102 includes required signal to interference ratios (SIRs) necessary to reach a given performance or quality metric, such as block error rate (BLER), bit error rate (BER), or throughput, or delay for a given radio bearer or service. As an illustrative embodiment, performance requirements may be expressed as a combination of one or more of the following: testing scenarios, a radio bearer, a required performance metric, and/or an amount of radio resources that are consumed for a given scenario. The testing scenario specifies under which external conditions the performance requirements are measured. The testing scenario may include the channel mode, speed of the channel, multipath profile of the channel, etc.

In step 204, the WTRU 102 determines whether to change performance requirements committed to by the WTRU 102. Frequently, higher-performance WTRUs require more complex receivers that impose a drain on the battery resources of the WTRU 102. Therefore, there may be situations when it is desirable for a higher-performance WTRUs to sacrifice a higher-performance for battery usage to preserve battery life. For example, a WTRU equipped with multiple receiver chains may wish to deactivate at least one receiver chain to reduce power consumption and preserver battery life. When the WTRU 102 decides to change performance requirements subscribed to by the WTRU 102, the WTRU 102 must inform the base station 104 of the decision.

In step 206, the WTRU 102 signals information indicating a change in performance requirements committed to by the WTRU 102. In 3GPP, for example, the information may indicate that the WTRU 102 has changed its receiver type. The WTRU 102 may signal the information from the WTRU 102 to the base station 104 at any point during a communication session. For example, in 3GPP networks, the signaling may be done through at least one of a common control channel signaling, a dedicated control signaling, and/or other signaling means in which the WTRU reaches the network.

As indicated above with respect to step 202, the WTRU 102 may signal information indicating a change in performance requirements subscribed to by the WTRU 102 on a per channel basis or a per service basis. The WTRU 102 may signal information to the base station 104 that includes performance requirements that the WTRU commits to satisfying, that includes a code or a field associated with at least one performance requirement, or that indicates a receiver model number.

Further, the WTRU 102 may signal information to the base station 104 that includes a time at which the change in performance requirements subscribed to by the WTRU is effective. The time at which the change in the performance requirement is effective may be given in relative terms or absolute terms. With respect to relative terms, the change may be effective relative to the time the WTRU signals the change. For example, the change may occur 1800 ms after signaling the change to the base station 104. With respect to absolute terms, the change may be effective at a certain point in time. For example, the change may occur precisely at a set point in time such as 18 h:16 m:13 s.

FIG. 3 is a flow diagram of a process 300 for inferring information regarding receiver performance in a WTRU 102 using channel quality measurements implemented by the system 100 of FIG. 1. The process 300 may be used when it is not necessary to determine information regarding receiver performance in a WTRU 102 with a high reliability.

As an illustrative embodiment, information may be inferred regarding receiver performance in a WTRU 102 operating in high-speed data packet access (HSDPA) mode using channel quality indicator (CQI) report messages. Any changes to the receiver capabilities in a WTRU 102 affect CQI messages. For example, if the number of receive antennas in a WTRU 102 changes, the change is reflected in the higher order statistic of variance at which the CQI is observed. For example, there is a sudden change in the average CQI and in the higher order statistics as well.

In alternative embodiments, the signaling of acknowledgement (ACK)/nonacknowledgement (NACK) information, feedback information (FBI), and/or power control information may be used to infer receiver performance in a WTRU 102.

In step 302, the WTRU 102 signals a plurality of CQI report messages to the base station 104. The CQI report messages contain information on channel conditions. The CQI is a value that describes the current quality of a propagation channel between the base station 104 and the WTRU 102. CQI is reported by the WTRU 102 to the base station 104 to enable the base station 104 to select a better transport block size and radio resources to better match channel conditions. The statistical properties of the CQI report messages may be used by the base station 104 to distinguish between receiver types with and without receiver diversity. Further, the CQI report messages may be used by the base station 104 to determine whether receiver diversity is enabled or disabled at the WTRU 102.

In step 304, the base station 104 receives the plurality of CQI report messages transmitted from the WTRU 102. The base station 104 may determine channel conditions within its service area using the plurality of received CQI report messages.

In step 306, the base station 104 infers information regarding receiver performance in the WTRU 102 based on the CQI report messages. The base station 104 infers the information by comparing the received CQI report messages from the WTRU 102 against previously received CQI report messages from the same WTRU 102. The variation of CQI report messages is larger for performance levels without receiver diversity in the WTRU 102. The base station 104 is able to detect sudden changes in the receiver performance of the WTRU 102 because changes in receiver performance causes changes to the mean value of the CQI report messages received at the base station 104.

The features of the present invention may be incorporated into an integrated circuit (IC) or be configured in a circuit comprising a multitude of interconnecting components.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including a wireless transmit/receive unit (WTRU) and a base station, a method for signaling information indicating performance requirements, the method comprising:
the WTRU signaling information to the base station, wherein the information indicates performance requirements that the WTRU commits to satisfying.

2. The method according to claim 1 wherein the signaling occurs when the WTRU establishes a communication session with the base station.

3. The method according to claim 1 wherein the signaling occurs during an existing communication session between the WTRU and base station using a dedicated channel.

4. The method according to claim 1 wherein the information indicates performance requirements that the WTRU commits to satisfying on a per channel basis.

5. The method according to claim 1 wherein the information indicates performance requirements that the WTRU commits to satisfying on a per service basis.

6. The method according to claim 1 wherein the information includes required signal to interference ratios (SIRs) necessary to reach a given performance or quality metric for a given radio bearer or service.

7. The method according to claim 1 wherein the information includes a code or field associated with at least one performance requirement.

8. The method according to claim 7 wherein the code or the field represents a particular receiver type that directly associates to a given set of performance requirements.

9. The method according to claim 1 further comprising:
the WTRU determining whether to change performance requirements subscribed to by the WTRU; and
the WTRU signaling information to the base station, wherein the information indicating a change in the performance requirements subscribed to by the WTRU.

10. The method according to claim 9 wherein the information indicates a time at which the change is effective.

11. In a wireless communication system including a wireless transmit/receive unit (WTRU) and a base station, a method for detecting performance requirements of a WTRU operating in high-speed data packet access (HSDPA) mode, the method comprising:
the WTRU signaling a plurality of channel quality indicator (CQI) report messages to the base station;
the base station receiving the plurality of CQI report messages from the WTRU; and
the base station inferring information regarding receiver performance in the WTRU based on the CQI report messages.

12. The method according to claim 11 wherein statistical properties of the CQI report messages are used by the base station to distinguish between receiver types with and without receiver diversity.

13. The method according to claim 11 wherein statistical properties of the CQI report messages are used by the base station to determine whether receiver diversity is enabled.

14. A wireless communication system comprising:
a base station; and
a wireless transmit/receive unit (WTRU) that signals information to the base station, the information indicating performance requirements that the WTRU commits to satisfying.

15. The system according to claim 14 wherein the information includes required signal to interference ratios necessary to reach a given performance or quality metric for a given radio bearer or service.

16. The system according to claim 14 wherein the information includes a code or a field associated with at least one performance requirement that represents a particular receiver type that directly associates to a given set of performance requirements.

17. The system according to claim 14 wherein the information is signaled on a per service basis.

18. The system according to claim 14 wherein the information is signaled on a per server basis.

19. The system according to claim 14 wherein the information is signaled when the WTRU establishes a communication session.

20. The system according to claim 14 wherein the information is signaled during an existing communication session between the WTRU and base station using a dedicated channel.

21. The system according to claim 14 wherein the information indicates a change in the performance requirements subscribed to by the WTRU.

22. The method according to claim 21 wherein the information indicates a time at which the change is effective.

23. A wireless communication system comprising:
a base station; and
a wireless transmit/receive unit (WTRU) that signals a plurality of channel quality indicator (CQI) report messages to the base station, wherein the base station infers certain information regarding receiver performance in the WTRU based on the CQI reports.

24. The system according to claim 23 wherein statistical properties of the CQI report messages are used by the base station to distinguish between receiver types with and without receiver diversity.

25. The method according to claim 23 wherein statistical properties of the CQI report messages are used by the base station to determine whether receiver diversity is enabled.
